(19) United States
(12) Patent Application Publication
(10) Pub. No.: US 2003/0135593 A1
(43) Pub. Date: Jul. 17, 2003

(54) Management system

(76) Inventors: Bernard Lee, San Diego, CA (US); Wei Guo, San Diego, CA (US)

Correspondence Address: BROWDY AND NEIMARK, P.L.L.C., 624 Ninth Street, N.W., Washington, DC, 20001, US

(21) Appl. No.: 09/962,617

(22) Filed: Sep. 26, 2001

(51) Int. Cl. G06F 15/173; G06F 15/16

(52) U.S. Cl. 709/223; 709/203

(57) ABSTRACT

A management system for managing an installation that engages in transactions via the Internet and that includes at least one server whose operation is controlled by a given operating system and that has first Internet connections, and at least one work station for providing management information to users associated with the installation. The management system includes: a management operating system connected to the server and having a second Internet connection separate from the first Internet connection, the management operating system being composed of components for collecting operating status data from the server of the installation in a platform-independent format; and a management server system having a third Internet connection for communication with the management operating system and composed of components for receiving the collected operating status data, converting that data into a second format and comparing operating status values represented by the data with threshold values.

### BACKGROUND OF THE INVENTION

The present invention relates to systems for managing installations, or facilities, that include servers and conduct transactions over the Internet.

Traditionally there are simple tools, either within the operating system of the server of such an installation or as a third party application, that allow monitoring and graphing of various operating parameters of the server, such as CPU, memory and disk utilization. These simple tools typically do not write metrics to a database for future data mining, and can only be used to track a single computer at a time, while the operating system is booting up and while it is running in the foreground.

There are third party software management packages that allow performance metrics to be gathered from the installation to be managed and stored in a centralized database for data mining, trend analysis and alarms management. Typically a “Management Agent” is loaded into the computer system to be managed. Such software management packages are traditionally designed for enterprise use, i.e. in the computer system of the installation to be managed, and the management database is designed to run within a virtual private network isolated from the Internet by firewalls.

Recently, management service providers, or MSP's, are starting to gain popularity. Providing software management as a service creates a unique challenge—the computer system to be managed, referred to herein as the target, and the performance metrics database are no longer within the same company and the same private network as the MSP. When traditional management agents are deployed, a number of security concerns are created. These are typically addressed by employing a substantial amount of router equipment, network filtering and firewall configuration efforts.

Effective management of increasingly complex operating systems and application software, will require new software management solutions for representing and handling new performance metrics and information from new features dynamically, without the need to write additional code.

A major challenge for writing efficient code for software management is how to represent data, and how to use them. Existing packages for software management require some kind of a template or schema for new functionality (e.g. MIB for SNMP applications), meaning that as new features and functions are added to the system to be managed, a new template or schema must be installed in the software management package before it will be able to report on or manage the new features and functions.

Software management requires the generation of reports relating to system performance. This involves the gathering of metrics, an operation that presents certain difficulties. For example, because of the distributed nature of a service provider environment, it is very difficult, if not impossible, to obtain samples at exact time intervals. A good management reporting server must account for missing samples, as well as duplicated samples. In addition, different reports will need different sample rates. For example, a report to graph activities for only the current working day will need as many samples as possible up to the past 24 hours. On the other hand, a trend report for the same activity throughout the current calendar year will only need one sample per day. However, if all of the samples ever collected for several years in order to do management reporting are retained in storage, the database will soon grow unnecessarily large, and become impractical to query on. Secondly, since SQL databases are queried using SELECT statements, adding flexibility to query functions is far more difficult to do than when using a traditional programming language, and optimization and efficiency is a primary concern. A secondary problem presented by variable sample rates is duplication of data. Some parameters, such as those that count and sum up traffic or utilization within a given time period, can only have one sample per period. A standard solution to account for multiple classes of time periods for reporting is to implement a different history database for each class of time period. This significantly reduces the flexibility and increases the complexity of the implementation of the management software.

### BRIEF SUMMARY OF THE INVENTION

The present invention provides a novel system that minimizes the above-mentioned security concerns and network configuration efforts and allows an end-user, or customer, of a MSP to automatically and interactively be notified of the health of the target IT resources, i.e., the server(s) and associated communication and data-handling components, in a user friendly and easy to understand environment.

The present invention also eliminates the need to install new templates or schemas in a software management package when new data collection points are added for monitoring additional parameters of a target operating system or application.

The present invention further makes transmitted software management information self-describing and readable by operating personnel, and at the same time easily parsed and converted by machines.

The invention additionally makes the writing of data collection scripts by third party developers or administrator easy and simple to understand.

The invention facilitates information exchange between different components of software management applications between platforms, transparent and independent of any programming language or tool, by use of two different and interchangeable formats for representing software management information.

The present invention further implements an end-user based tool, designated herein as an instant management messenger (IMM), which effectively eliminates the need for specialized management consoles. The IMM operates in conjunction with a management operating system (MOS) and a management object model (MOM), also according to the invention, to provide interactive management services.

To achieves these results, the invention provides a management system for managing an installation that engages in transactions with individuals via the Internet, the installation including at least one server whose operation is controlled by a given operating system and which includes first Internet connections, and at least one workstation for providing management information to users associated with the installation, the management system comprising:

a management operating system physically connected to the server of the installation and having a second Internet connection separate from the first Internet connection, the management operating system comprising means for collecting operating status data from the server of the installation in a platform-independent format; and

a management server system having a third Internet connection for communication with the management operating system and comprising means for receiving the collected operating status data in the platform-independent format, converting that data into a second format and comparing operating status values represented by the data with threshold values.

Furthermore, the present invention provides a single database schema for history storage, which permits the use of standard metrics, hourly summary metrics, daily summary metrics, and in fact metrics with any sample rate.

According to the invention, the number of samples stored is reduced effectively as they age. For example, samples for the last 24 hours will be obtained and stored at 5 minute intervals, whereas samples for the last month will be provided as hourly intervals and samples for the last year will be provided at daily intervals.

The invention provides for optimization of database queries for obtaining performance samples so that minimum server processing time is required, and scalability for the management service provider can be achieved.

### BRIEF DESCRIPTION OF THE DRAWING

FIG. 1 is a block diagram showing a system according to the invention in combination with the basic components of the installation of a customer.

FIGS. 2 and 3 are block diagrams of components of, respectively, a MOS and a MSP according to the invention.

FIG. 4 is a pictorial view of one example of an IMM applet displayed at a user work station.

### DETAILED DESCRIPTION OF THE INVENTION

In the following description, certain terms employed herein have the following definitions:

customer—a business or institution that uses the services of a management service provider (MSP);

user—an individual associated with, or employed by, a customer;

target—a server belonging to the customer;

client—software provided by the MSP and installed in a user's work station;

metrics—data representing measurements of parameters of interest to the customer;

probes—programs or scripts that run in the target host operating system space that actually does the performance metrics gathering. The probes may be hardwired to only receive messages from the associated target;

manager—software comparable to a device driver;

nfs—a network file system;

DNS—domain name services;

physicaldisk—an actual physical disk drive;

drill-down—the act of proceeding downwardly in a table, e.g. from a summary level to detailed information; and

roll-up—transfer, in some form, of information from a lower level to a higher level.

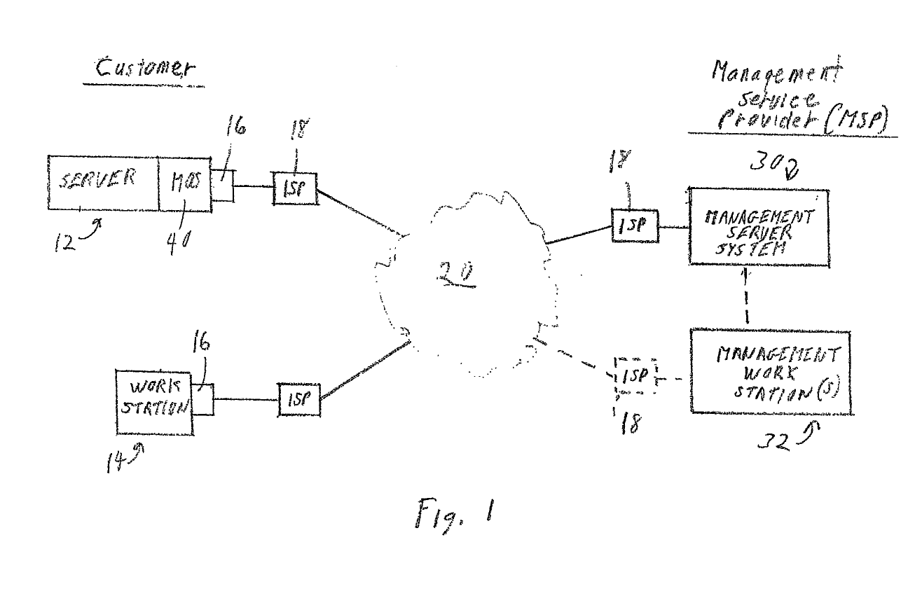

FIG. 1 shows the basic components of a system according to the invention in which management services are provided to a customer by a MSP. The customer's facility includes at least one server 12, which is a target, as defined above, and at least one workstation 14 staffed by a user or users, who are personnel assigned to monitor the operating status of server 12. Server 12 and workstation 14 are each normally connected via a respective firewall 16 to a respective Internet service provider (ISP) 18 connection. However, workstation 14 could possibly be connected directly to server 12. Each ISP connection is connected to the Internet 20.

Server 12 is provided with a host operating system and is connected to other components (not shown) and to the Internet via a separate ISP connection or connections (not shown). These components and connections are already known in the art. In fact, it is here assumed that the management services according to the invention will be provided to customers having an existing facility. Such customers would typically be business or institutions that market merchandise or services or provide information over the Internet using equipment that is already commercially available.

The MSP facility is composed essentially of a server system 30 and one or more management work stations 32. Server system 30 is connected to the Internet via a respective ISP connection 18 and may, if desired, be equipped with a firewall. Management work station or stations 32 may be connected to Internet 20 via one or more ISP connections 18 or may be connected directly to server system 30, these alternatives being represented by broken lines.

A system according to the invention includes, in addition to the MSP hardware and software, a management operating system (MOS) 40 that is installed in server 12. MOS 40 is shown as being interposed between the parts of server 12 used by the customer and the associated firewall 16. MOS 40 provides a layer of isolation between the parts of server 12 used by the customer and the ISP connection 18 used to communicate with the MSP. Specifically, MOS 40 is provided to prevent the security of the customer's facility from being compromised as a result of its connection to the MSP. However, MOS 40 is, in fact, software provided by the organization that operates the MSP and installed in server 12.

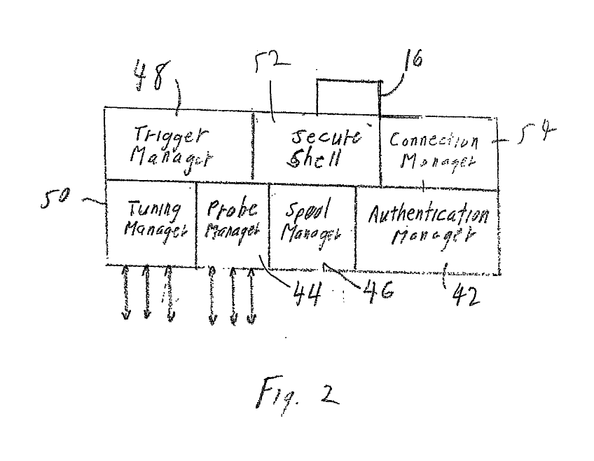

FIG. 2 schematically illustrates an exemplary composition of MOS 40, made up of the following software modules: an authentication manager 42; a probe manager 44; a spool manager 46; a trigger manager 48; a tuning manager 50; secure shell 52; and a connection manager 54.

Authentication manager 42 stores a database of the users and access control rights of the users within MOS 40. It also authenticates a user of MOS 40 using a password or some other commonly used authentication algorithm for authenticating users in operating systems. One feature of the invention is that, by implementing an isolated user and access rights database within authentication manager 42 of MOS 40, which is completely independent from the user and access rights database in the target host operating system associated with server 12, the management services provider will only be granted access rights to execute commands and functions implemented within MOS 40.

Probe manager 44 collects performance metrics from the operating system or application of the target host through various probes. It then writes the performance metrics into XML files in a spool directory in the target host. To ensure maximum security, probe manager 44 is only capable of executing probes. Data is always written to a local XML file in the target host operating system, and is never passed back to MOS 40 directly. Furthermore, probes can only be installed using commands in the target host operating system, not in MOS 40. This prevents anyone who has access to MOS 40 from installing malicious code in an attempt to gain unauthorized access to the target host operating system.

Spool manager 46 retrieves, on demand, the XML files written by the probes, as instructed by the user or MSP, using manual or automated commands. Since spool manager 46 acts as a device driver for MOS 40, the XML spool directory is presented as the only file system in the target host operating system that is accessible to MOS 40, therefore closing any potential security breaches into the host target operating system.

Trigger manager 48 stores thresholds of different performance metrics collected by the probes. In the event that one of the performance metrics should exceed a pre-set threshold, trigger manager 48 will produce an alarm to the user through the MSP, using any one of the available communication transports.

Tuning manager 50 runs proactive tuning scripts installed in the target host operating system. For security purposes, proactive tuning scripts can only be installed in the host target operating system. The only action tuning manager 50 is allowed to perform is to invoke a tuning script.

Secure shell 52 is the user interface to MOS 40. It allows the issuance of commands from standard client programs such as OpenSSH. Since MOS 40 acts like an independent operating system from the target host, a separate, independent IP address can be assigned to MOS 40. Other modules, such as a Web server or SMTP server, can be added into MOS 40 for its exclusive use, independent of the target host. Such Web or SMTP server's sole function will be to allow a user or MSP to access and control MOS 40, using other standard client tools to perform software management functions on the target host, as if a separate, secure machine is used to manage the target host operating system and applications. If the user chooses to not allow any external host to initiate traffic to pass through firewall 16 to MOS 40, connection manager 54 can be provided to initiate a connection actively to the MSP. Network Address Translation (NAT) techniques can be used to completely hide the MOS 40 and Server 12 from the Internet and making it unreachable unless connection manager 54 first initiates a connection to the MSP.

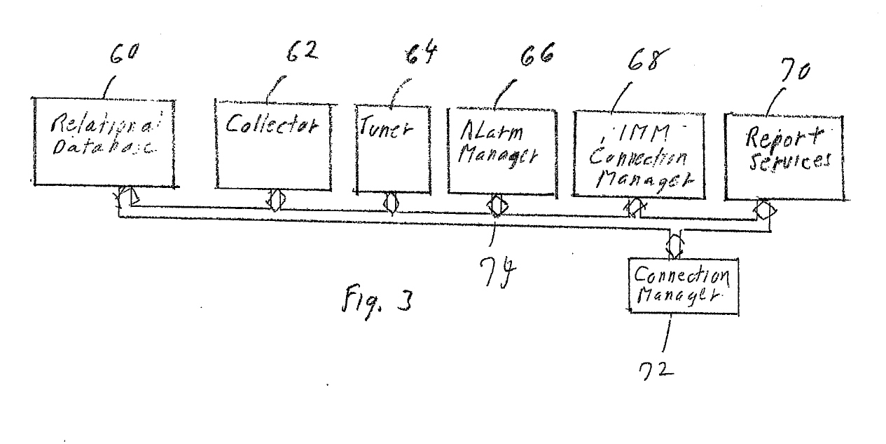

FIG. 3 shows one example of the manner in which management server system 30 can be organized. Specifically, system 30 can be composed of one or several servers providing the following functional units: a relational database 60; a collector 62; a tuner 64; an alarm manager 66; an instant management messenger(IMM) connection manager 68; report services 70; a further connection manager 72; and a bi-directional bus 74 interconnecting all of the above-mentioned units.

Relational database 60 may be installed in, for example, an MSSQL server and may provide bus 74. The present invention employs a specific type of IMM which bears the trade name Procuro™ Instant Management Messenger (PIMM™). The details of this utility will be described in detail below.

Relational database 60 contains a CPU and software to control all operations of server system 30. Collector 62 retrieves metrics in XML format from MOS 40 and converts the metrics to data in dot notation format. The data in this format is then transferred to and stored in relational database 60.

Tuner 64 operates to perform proactive tuning of a customer's target servers. For example, such tuning may involve reallocation of target server resources to optimize performance based on the current level of server utilization. More specifically, this tuning may act to redirect calls from servers which are experiencing heavy utilization to servers having greater spare capacity. Tuning can also take the form of a response to a software crash, due for example two bugs, restarting the software, blocking selected callers, for example those identified as hackers, detecting memory leaks, which are losses of availability of memory locations due, for example, to software imperfections, and selectively deleting data from storage, for example by defining priority of files and deleting files as necessary starting from the files having lowest priority.

Alarm manager 66 can be coupled to compare metrics collected by collector 62 and stored in database 60 with existing thresholds in order to generate messages and alarms whenever a threshold is exceeded.

Connection manager 68 communicates with an IMM, to be described in detail below and operates to execute commends produced by a user.

Report services 70 generate reports that will be available to personnel at work station(s) 32. Commands issued by a user, for example, at workstation 14, will be transmitted to connection manager 68, and to database 60 and possibility to tuners 64. If a commend sent by a user, for example from a work station 14, is an instruction to perform a tuning operation in server 12, tuner 64 will generate an appropriate instruction that will be transmitted via shell 52 to tuning manager 50 to cause tuning manager 50 to invoke an appropriate tuning script. The other connection manager 72 communicates with connection manager 54 in MOS 40 to allow MOS 40 to actively initiate a connection to the MSP to send metrics should the user choose to not allow any external host or service outside firewall 16 to initiate a connection to server 12

The collection of metrics, or data, under control of probe manager 44 is one element of a management object model (MOM) that represents an approach to obtaining software management information that is both structured and human readable. Furthermore it is designed to be self explanatory and platform independent. Specifically, the model obtains information in a first, platform independent format, the presently preferred format being XML, and converts the information in that format, in collector 62, into a second format that is compatible with the management system software. One example of such a second format is plain text using dot notation. This conversion can be carried out with an appropriate algorithm, one example of which will be described below.

The first format, XML, is a known format that is composed of different levels of tags. An authorative reference to XML can be obtained from the World Wide Web Consortium. The current latest specification is XML 1.0Second Edition, dated Oct. 6, 2000. Full text of the specification can be found at www.w3.org/TR/REC-xml.

The first level is always the service provider ID. For example, if the MSP is Procuro™, the first level tag will always expressed as

<procuro>

</procuro>

The second level can be either <config>, or the category of the target to be managed. In the reference implementation, there is <os> for operating systems, or <app> for applications. <config> is a special tag. Under the <config> tag, information specific to the host at the time of metrics collection, and static information from the host that had been changed since the previous metric collection, can be sent to the MSP.

The third and subsequent levels are platform and application dependent. For <os>, the third level will be the subsystem managed. For <app>, the third level will be the name of the application to be managed.

For the implementation according to the invention, the value of any parameter is always associated with a leaf node. A leaf node is a node that has no further branches or child nodes after it. For leaf nodes, several tags are reserved:

instance—an integer that uniquely identifies each occurrence of the same type of items under management. For example, if a system has four CPU's, there will be four instances, numbered from 0 to 3.

nvalue—the current numeric value of the parameter

ivalue—the current integer value of the parameter

lvalue—the current long integer value of the parameter

pvalue—the current percentage value of the parameter

bvalue—the current Boolean value of the parameter

svalue—the current string value of the parameter

dvalue—the current date-time value of the parameter

Typically, dvalue will only be used for timestamps, while svalue and bvalue will only be used for persistent parameters. In order make possible the charting of performance metrics, the parameter value would be either one of nvalue, ivalue, lvalue or pvalue.

A typical first XML sample representation of the MOM could look like the following:

<procuro>

<config>

<timestamp dvalue=06/27/2001 21:05:00 />

</config>

<os>

<cpu>

<utilization instance=0 pvalue=0.43 />
<utilization instance=1 pvalue=0.28 />

</cpu>
<memory>

<available ivalue=133442700 />

</memory>

</os>
<app>

<apache>

<connections ivalue=20 />
<websites>

<com>

```
<fubar>
    <www>
        <hitsperhour
```

ivalue=235 />

```
    </www>
</fubar>
<procuro>
    <www>
        <hitsperhour
```

ivalue=320 />

</www>
</procuro>

<com>

</websites>

<apache>
<sendmail>

<queuesize ivalue=6 />

</sendmail>

<app>

</procuro>

In the above listing, apache is one type of server software, connections are the number of current connections, represented by a value, each utilization instance number identifies a specific database where the associated value, such as pvalue, is stored.

As indicated by the above example, static occurrences of resources, such as cpu, will be enumerated using instance numbers. Dynamic occurrences, such as the different web sites hosted in Apache, will be enumerated using an XML subtree.

Instance numbers are used whenever the occurrences will remain static. CPU is one example, since the addition of new CPU's to a computer will occur rarely. Another example will be physicaldisk, since the addition of new hard disks to a server will also be rare. Logical or nfs mounted volumes, on the other hand, will be expressed using an XML subtree, as new volumes can be created, mounted and dismounted relatively frequently. XML subtrees are used to express named occurrences of monitored data. Examples will be different databases in a Microsoft SQL Server, different web sites on an Apache server, or different domains managed by a DNS server.

When static occurrences of resources require naming or specification of parameters and information, the <config> tag will come in. For example, to specify the names and static information for display and informational purposes for physicaldisk instances, the following second XML sample representation may be used:

```
<procuro>
        <config>
            <os>
                <disk>
                    <label instance=0 svalue=boot />
                    <label instance=1 svalue=data />
                    <sizegb instance=0 ivalue=20 />
                    <sizegb instance=1 ivalue=80 />
                </disk>
            </os>
        </config>
</procuro>
```

The second format is, for example, expressed in dot notation. It is also known as ObjectID, not unlike the ObjectID of the SNMP MIB specification, except that it contains text rather than numbers.

ObjectID's are specified based on the full traversed path from the root of the XML file. In the first XML sample representation above, the dot notation ObjectID's are parsed to the following:

| | Instance | |
|---|---|---|
| Object ID | ID | Value |
| os.cpu.utilization | 0 | 0.43 |
| os.cpu.utilization | 1 | 0.28 |
| os.memory.available | 0 | 133442700 |
| app.apache.connections | 0 | 20 |
| app.apache.websites.com.fubar.www. | 0 | 235 |
| hitsperhour | | |
| app.apache.websites.com.procuro.www. | 0 | 320 |
| hitsperhour | | |
| app.sendmail.queuesize | 0 | 6 |

In the second XML sample representation above, the dot notation ObjectID's are parsed to the following:

| Object ID | Instance ID | Value |
|---|---|---|
| config.os.disk.label | 0 | Boot |
| config.os.disk.label | 1 | Data |
| config.os.disk.sizegb | 0 | 20 |
| config.os.disk.sizegb | 1 | 80 |

Management information collected from the target is transmitted using the XML representation. When it arrives at MSP system 30, it will be parsed into the dot notation ObjectID format in collector 62, and stored verbatim in the history database, as described earlier herein with reference to FIG. 3.

As the target operating system and managed applications receive enhancements, new parameters will be put under monitoring, and new XML subtrees will be included in the data collection process. The XML performance metric files will be parsed into additional dot notation ObjectID's at the management service provider. A list of all the instances that can be charted or reported can be obtained by an ANSI SQL statement similar to the following:

SELECT DISTINCT object_id, instance_id from p_history_{—}5 min WHERE host_id=<host_id>

ObjectID is a name based on the dot notation as specified herein that contains, in the name itself, a self description of the application, group and name of the performance parameter it identifies. Instance ID enumerates the different occurrences of the same measurable parameter named by the same ObjectID within a single system. HostID is a 128 bit globally unique ID that uniquely identifies any host, or target, that will ever be managed by any installation instances of the management software.

The dot notation ObjectID should be self explanatory for users of the system, and added monitored parameters will appear at MSP system 30 without the need to install any schema or template. A more descriptive label can always be added either manually, or be specified in <config> tags that are parsed at the Management Service Provider. Labels are purely optional and their absence will not cause any feature of the management software to be unavailable.

The following listing is an implementation of the Perl code that can be used to parse the XML representation into the dot notation as specified for the MOM.

```
my $p = new XML::Parser( );
$p->setHandlers (
            Start => \&Start_handler,
              End => \&End_handler,
          Default => \&Default_handler
);
eval {$p->parse($xml)};
            print “Caught error: $@\n” if $@;
            print “Done.\n”;
sub Start_handler {
            my $p = shift;
            my $el = shift;
            $objectid[$objectlevel++]=$el;
            $instances[$objectlevel+1] = 0;
            $oid=“”;
            for ($i=0;$i < $objectlevel;$i++)
            {
                if ($i > 0)
                {
                    $oid .= “.”;
                }
                $oid .= $objectid[$i];
            }
            $iid = $instances[$objectlevel];
            while (my $key = shift) {
                my $val = shift;
                $hashkey = $oid.“.”.$key;
                $objecthash{$hashkey}[$iid]=$val;
            }
            $instances[$objectlevel]+=1;
}
sub End_handler {
  my ($p, $el) = @_;
  pop (@objectid);
  $objectlevel−−;
}
sub Default_handler {
  my ($p, $str) = @_;
}
```

The IMM according to the present invention uses the data that has been converted into the second format to monitor, manage and graphically represent software management information and sends this information to a user's work station(s) 14, without requiring a management console of the type having a computer display that is dedicated for the purpose of displaying management information at all times. In contrast to conventional management consoles, the IMM is designed to normally operate in the background and is represented, upon startup, by an icon in an icon tray of a user's desktop. The MSP automatically detects and notifies the user of any abnormalities in the status of the monitored services, without any operator intervention, by causing an IMM Applet to be displayed on the desktop of the monitor of user work station 14. An IMM Applet is a form-based application. It runs as a small window, showing the status of each managed application or server group according to business functions. An IMM Applet can show certain dialog boxes for various functions. The user can also actively request the status of the monitored services, i.e. open the IMM applet, whenever desired by selecting the icon.

The IMM establishes a “system management console” from within the icon tray using bi-directional system management communications tools to monitor and manage client IT resources, including hardware, operating systems software, middleware and/or application software. As noted above, in contrast to a typical Management Console in a network operation center, which needs to occupy the entire screen at all times so that an operator can monitor events within the console display, The “system management console” according to the present invention is normally not displayed in the user workstation. It is only launched if a user wants to “drill down” on an exception status or message, which is indicated by flashing icons in the icon tray, or task tray.

The IMM is the end user management tool for an MSP according to the invention. The IMM utilizes proven user interface concepts of instant messaging to monitor IT resources and services on an enterprise-wide basis.

Known software that involves similar technology include: Mirabilis™ ICQ, AOL™ Instant Messaging, Yahoo™ Messenger, MSN™ Messenger. All of these known software are used for managing interpersonal communication and messages. The present invention applies the same kind of user interface and concepts to software management in that, instead of a user adding contacts for individuals and sending and receiving messages to and from these individuals, the will add the identifications of machines, group them, receive messages from the machines for changes of operating status, and send predefined messages to machines to perform tuning and self healing actions.

The IMM monitors, manages and reports on the health of any/all IT resources under control of the MOS over the Internet. It automatically monitors and measures custom thresholds for each resource based upon the customers' unique requirements. The graphical properties of the management messenger will automatically change as the status of the IT resources changes, will automatically display “Alerts and Alarms”, will automatically take proactive management measures in order to avoid a threshold violation to maintain high-availability, allows the user to “drill-down” and/or “roll-up” on any/all resources under management to identify the underlying problems and automatically provides interactive reporting tools and charts on every measured resource (collection point). Each user can customize his personal IMM for his own specific needs, whether the need is to provide IT metrics or business metrics. There is no limitation of the number of users that use the IMM technology to manage a specific resource. The IMM automatically provides resource specific management and communications tools to support the managed resources, i.e., alerts, alarms, self-healing scripts, reports, messages, chat, etc.

The IMM technology according to the invention helps to respond to the fact that computer operating systems and application software are becoming progressively more complex in functionality and features and to the ever-increasing need to know more about the performance metrics of a production operating system and its associated applications.

Administrators of a client installation will install the IMM in all of their workstations. The IMM will start up minimized and will be represented by a status icon in the operating system icon tray, unobtrusive to the user. In Windows™, the icon tray is known as a task tray. The status icon can take a variety of forms, depending essentially on the operating status of the client installation. If everything that is being monitored is within performance standards, then no action is taken by the IMM and it can remain minimized and the appearance of the icon will not change. However, if something goes wrong, or one of the performance metrics falls outside of a predefined threshold, the task tray icon signals this, as by beginning to flash. In addition, the form, such as color and/or shape, of the icon can be changed in a cyclic manner to provide different items of information. Cycling among different sets of flashing icon configurations alone will be sufficient to convey to the user the general status of the servers he is managing. When the user “drills down” on the icon with a mouse or other pointing device, a dialog box will pop up to provide detailed information. Different status icon forms that may be used include:

| | |
|---|---|
| Non cycling: | |
| Solid Green | Everything is OK |
| Solid Red | Lost connection to Service Provider |
| Cycling: | |
| Green | Connected to Service Provider |
| Yellow | One or more metrics currently exceed their |
| | threshold values |
| Red | One or more services are currently down or |
| | inaccessible |
| Message | One or more messages currently awaits the |
| | user |

Other icons can be added to convey standard or application specific information.

By way of example, normally a status icon will have a selected form and a fixed green status icon will be displayed. If the icon is red, this means that there is no connection to the MSP. Alternating green and red status icons mean there is a connection to the MSP, but one of the managed services is down. Cycling among green, yellow and red status icons means that there is a connection to the MSP, one or more services managed is down, and one or more services have performance values exceeding their respective thresholds. There can also be icons having other forms that represent other functions. For example, an icon having a second selected form can indicate that a message has been sent to the user. Cycling among green and yellow status icons and the message icon means there is a connection to the MSP, one or more services have performance values exceeding its threshold, and one or more messages await the user.

At any time, the user can, for example, double click on the task tray icon to bring up an IMM Applet. Other colored icons can visually denote status and performance of such application or server groups, and the user can expand the groups to see various servers, components, services, and eventually click on hot links to launch a browser window to see all status and parameters available to the application in question.

A right click on any item anywhere in the drill down path, can cause a context menu to pop up, showing all actions available for the administrator to control that particular server, platform, application or component in question.

Each user can customize the look and feel of the IMM by modifying the “skin” and can modify and customize the IT resources to be managed.

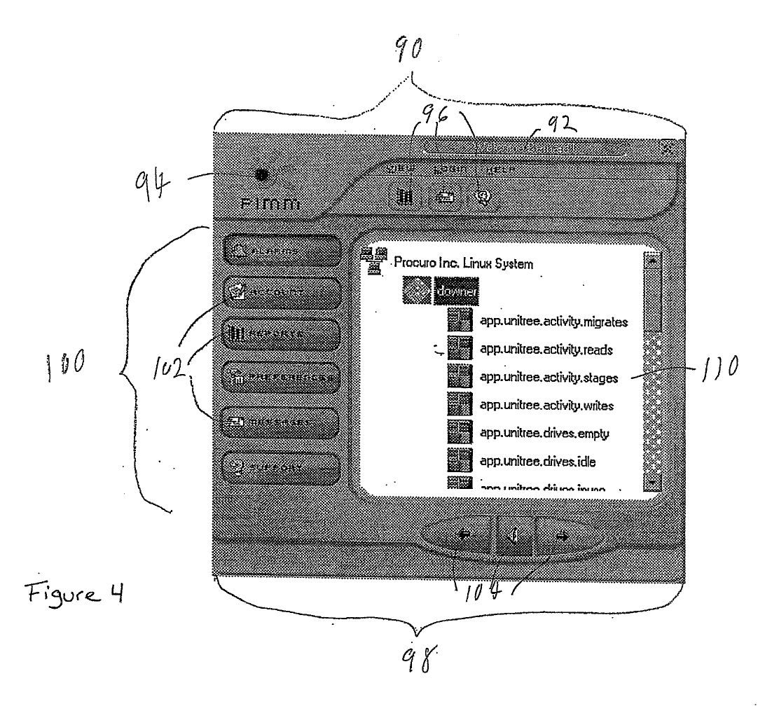

The IMM is designed to provide both systems administrators and end users with a user friendly and familiar interface to the IT environment. This interface is in the form of a form-based application having, as shown in FIG. 4, three basic components: 1) a skin 90; 2) a frame 100 containing tab buttons, or function keys, 102; and 3) a window 110.

The skin includes a grey bar 90 at the top of the box that displays the user's name in an area 92 at the very top and can perform a ticker tape-like function to display a communications bulletin to all users. In the top left-hand corner there is provided an icon 94 that is also an interactive element. Icon 94 changes the color of the bars on the icon depending upon the status of the monitored services. Icon 94 cycles among different color schemes to convey the overall status information of all hosts that are managed by the user. These are the color schemes currently used in the reference implementation:

| | |
|---|---|
| Non cycling: | |
| Solid Green | Everything is OK |
| Solid Red | Lost connection to Service Provider |
| Cycling: | |
| Green | Connected to Service Provider |
| Yellow | One or more Metric currently exceeds it |
| | threshold values |
| Red | One or more services are currently down or |
| | inaccessible |
| Message | One or more messages currently awaits the |
| | user. |

Regardless whether the IMM Applet is closed or in the minimized State, a similar set of icons in the Windows® task tray displays or cycles through the same states, displaying the same set of summary status information. The bars will flash green when all is well, yellow when a service within the managed services are running slow and red if a service is down or below an acceptable threshold level. When the IMM applet is in its minimized state, icon 94 appears in the end users icon, or task, tray on the bottom right hand corner of the desktop.

The skin further includes a grey bar 98 at the very bottom of the box, where there can be provided the logo of the MSP in the bottom right hand corner, while the bottom left hand corner can be reserved for a customer or partner logo. Directly below area 92 there are tool or action buttons 96 that directly relate to a selected one of the tab buttons 102 on the left hand-side of the box in the frame 100. Tool buttons 96 are dynamically associated with tab buttons 102 and relate directly to the IT resource that is highlighted in window 110. When a tab button 102 is selected, as by the action of a pointing device, appropriate tool buttons 96 are displayed in skin 90.

Tab buttons, or function keys, 102 are associated with a highlighted IT service within window 110. An IT Service could be, but is not limited to any of the following: a Database Server Instance; a Web Server Instance; a Middleware Server Instance, such as BEA Weblogic Objects, Orcacle Objects, or Microsoft Transaction Server Objects; or an Email Server Instance. Each tab button 102 has an specific associated tool bar with multiple tool buttons 96 that perform specific actions that appear in a separate pop-up browser window (not shown). Located on the bottom section of the frame 100, the box contains three additional function keys 104 that can be selected to perform common user functions, such as back (previous screen); sound (plays voice message); and forward (next screen).

The following is a list of exemplary tab buttons 102 with the associated tool or action buttons 96:

| Tab Button | Tool button or Action Buttons |
|---|---|
| Alarms | Reports; Messages; Chat; Support |
| Accounts | Profile; Billing; Service Levels; Add Services |
| Reports | Summary; Daily; Weekly; Monthly; Annual |
| Preferences | Frame Color; Style Type |
| Messages | Send Email; View Email; Broadcast Messages |
| Support | Tech Support; Email Support; Chat Support |

The buttons enumerated above are merely exemplary and the specific nature of the function that each would initiate will be apparent to those skilled in the art. Window 110 contains a listing of the actual IT services being monitored and managed, displayed in a tree-like structure.

The entries in window 110 are interactive and the window will display the current status of each of the IT service(s) under management. The tree-like design supports drill-down and roll-up capabilities to help identify and perform remedial action required to bring the managed service back to an acceptable service level as defined by the customer. When collapsed, the window will display only the Groups that denote logical business functions, e.g. Accounting, Marketing Web Services, Corporate EMail. Double clicking a group will expand it to display a list of Hosts that provide IT services to the group. Double clicking a Host will display a list of objects that identifies the IT services that runs under the host. Double clicking an object will expand the enumerated instances that exists for that particular IT service. Double clicking any expanded item will collapse the displayed subitem. A leaf object is always at the instance level. Alarms, threshold triggers, up/down status and informational messages always occur at the leaf object. Such information is always “rolled-up” to the top, from the instance to the object to the host to the group, and then to icon 92 and the Task Tray Icon.

Each user will have a customized view of his/her display. The user's window 110 will display only the IT services for which user rights have been assigned by the customer's system administrator.

All of the display and interactive features described above can be implemented by software that is already known in the art or that can be easily created by competent programmers based on principles known in the art.

According to the further feature of the invention, data needed for generating reports are stored only for defined time periods in order to reduce the amount of memory or storage required to store that data. One example is a parameter, such as the number of times the customer facility is accessed, also known as “hits”, that is measured during successive five minute intervals and for which hourly, daily and monthly reports are to be generated. At the end of each hour, all measurements made in the five minute intervals during that hour are summed to produce an indication of the total number of hits for that hour. The individual measurements for the five minute intervals are stored and can be used to indicate the pattern of hits during that hour.

In a similar manner, the hourly values are summed to produced daily total values and to produce monthly total values.

According to the invention, the stored data is deleted periodically in a manner to preserve report data for an appropriate period of time. According to the invention, each type of data is saved for a period of time bearing a correspondence to the time period that it covers.

For example, according to one embodiment, the data representing the number of hits during each five minute interval are deleted twenty-four hours from the end of the respective five minute interval, the report data representing each one hour period are likewise deleted one week from the end of the respective one hour period, the report data representing each one day period are deleted one month or thirty days from the end of the respective one day period and the report data representing each month are deleted one year after the respective one month period. Different delete times can be set by the service provider according to the requirements of the customer. Data from customers requiring a higher service level can be retained for longer time periods.

The following is a more detailed description of the storage of metrics according to the invention.

When metrics are gathered from the target to be managed, they are first put into a single history database. The history database will have 5 indexed fields—host_id, object_id, instance_id, time_stamp and interval_time. Host_id, object_id and instance_id are the same as previously defined. Interval_time is the starting time of the interval that each sample is rolled-up into. (For 5 minute intervals they will be Sep. 7, 2001 00:00, Sep. 7, 2001 00:05, Sep. 7, 2001 00:10, Sep. 7, 2001 00:15 etc, for hourly intervals they will be Sep. 7, 2001 00:00, Sep. 7, 2001 01:00, Sep. 7, 2001 02:00 etc). Time_stamp will be the actual arrival time of the metric sample.

Calculation fields are used to break down the time_stamp field into year, month, day and hour fields, which are also indexed.

As performance metrics are gathered, the five parameters—host_id, object_id, instance_id, time_stamp and interval_time are inserted verbatim into respective index fields of a first database, p_history_{—}5 min. The first database will have the 5 indexed fields, plus the fields “type”, “value”, “total”, “average”, “minimum” “maximum” and “samples”. “Type” denotes the data type of the metric (Integer, Percentage, Longint, Real), “samples” denotes the number of metrics that are actually gathered within the time period, and “value”, “total”, “average”, “minimum” and “maximum” are exactly as their names imply. Below is the stored procedure used to summarize a metric collect at any time into the table p_history_{—}5 min.

DEFINE PROCEDURE insert_history_5mins

@host_id uniqueidentifier,
@object_id varchar(50),
@instance_id int,
@realtime datetime,

@real_value_str varchar(50)
declare @tmp_datetime datetime
declare @times int
declare @datestring varchar(30)
declare @tmp_min_value numeric(18,2)
declare @tmp_max_value numeric(18,2)
declare @real_value numeric(18,2)
declare @temp int
/* interval is 5 mins */
set @times = datepart(mi,@realtime)/5
set @datestring = convert(varchar(30),@realtime)
set @datestring =stuff (@datestring,

(charindex(‘:’,@datestring)+1)
,2,convert(char(2),@times*5))

set @tmp_datetime = convert(datetime,@datestring)
/* handle input real data */
select @temp=charindex(‘%’,@real_value_str)
if @temp=0

select @real_value= convert (numeric(18,2),

@real_value_str)

else

select

@real_value=convert(numeric(18,2),substring(@real_value_str,1,
@temp-1) )

| select | @tmp_min_value=min_value, |
|---|---|
| | @tmp_max_value=max_value |
| from p_history_5 min | |
| where | [host_id]=@host_id and |

[object_id]=@object_id and
instance_id=@instance_id and

interval_date_time=@tmp_datetime

if @@rowcount=1

begin /* update data */

```
if @real_value>@tmp_max_value
  select @tmp_max_value=@real_value
if @real_value<@tmp_max_value
  select @tmp_min_value=@real_value
update p_history_5min
```

set realtime=@realtime,

```
  real_value=@real_value,
  sample_times=sample_times+1,
  total_value=total_value+@real_value,
  avg_value=
```

(total_value+@real_value)/(sample_times+1),

min_value=@tmp_min_value,
max_value=@tmp_max_value

where [host_id]=@host_id and

[object_id]=@object_id and
instance_id=@instance_id and
interval_date_time=@tmp_datetime

end

else

begin /* insert new data */

if @temp=0

insert p_history_5min values
(newid( ),

@host_id, @object_id,
@instance_id, @realtime, ‘’,
@real_value, 1, @real_value,
@real_value, @real_value,
@real_value, @tmp_datetime)

else

insert p_history_5min values (
newid( ),

@host_id, @object_id,
@instance_id, @realtime, ‘%’,
@real_value, 1, @real_value,
@real_value, @real_value,
@real_value, @tmp_datetime)

end

No database lookups are necessary when the MOM ObjectID is used, as each ObjectID already uniquely identifies what exact performance metric it refers to.

There will be two kinds of performance metrics—standard metrics and summary metrics. Standard metrics, such as “CPU utilization”, can be gathered as often as possible without affecting the accuracy of the report provided. They can be inserted into the history database at any time verbatim. Summary metrics, such as “Number of Reads per Hour” or “Number of Hits per Day”, can only have one meaningful sample per time period. Before the insertion of a summary metric, any old metric of the same object within that particular time period must be either overwritten or averaged into. The stored procedure above explains the algorithm to insert any type of metric. Both standard and summary metrics will be stored in the same manner. Reporting on standard and summary metrics will be different, and they will make use of the “value”, “total”, “average”, “minimum” “maximum” and “samples” fields to make the resulting data meaningful. The p_history_{—}5 min field will contain all initial metrics. i.e. the metrics will not be “replaced”, but “rolled up” into a single summary value.

A second history database and a third history database, namely p_history_hourly and p_history_daily, are used to provide hourly samples and daily samples. Other databases may also be provided. Every day at predefined intervals, a stored procedure will be triggered to roll up the samples from the p_history_{—}5 min database into the p_history_hourly database and then from the p_history_hourly database to the p_history_daily database. The Average function can be used to summarize all data. Standard metrics, such as CPU utilization, can be averaged and it will mean the same if 5-minute samples are averaged into hourly and then daily samples. Even Summary Metrics can be averaged without loss of meaning. Rolling up of hourly “reads per hour” samples into daily “reads per hour” averages will represent the average reads per hour for the entire day. Therefore, the same rollup algorithm can be used, and a single history table schema can be used to store, roll up and summarize all kinds of performance metrics described above. As described above, the average, sum, maximum, minimum values and the total sample counts are all stored in a single database record during a roll-up.

Since the history databases contain the total, average, minimum and maximum, as well as the count, any programmer with reasonable knowledge will be able to extract meaningful information out of the tables using the language tool of their choice. Use of dot-notation format in the history databases makes it possible to insert new kinds of metrics to the databases without the need to define the new kinds of metrics prior to insertion.

The following listing contains SQL statements used to migrate reporting information from the raw history file in p_history_{—}5 min to the hourly history summary in p_history_hourly and from the hourly history summary to the daily history summary in p_history_daily.

CREATE PROCEDURE migrate_history AS
UPDATE p_sysparams
SET latest_hourlyhistory = ‘1900/01/01 00:00:00’,

latest_dailyhistory = ‘1900/01/01 00:00:00’

UPDATE p_sysparams
SET latest_hourlyhistory = p_history_hourly.interval_date_time
FROM p_history_hourly
WHERE p_history_hourly.interval_date_time = (SELECT

MAX(interval_date_time) FROM p_history_hourly)

UPDATE p_sysparams
SET latest_dailyhistory = p_history_daily.interval_date_time
FROM p_history_daily
WHERE p_history_daily.interval_date_time =

(SELECT MAX(interval_date_time) FROM p_history_daily)
INSERT INTO p_history_hourly

([host_id], [object_id], instance_id, sample_times,
total_value, avg_value, min_value, max_value,
interval_date_time)

SELECT [host_id], [object_id], instance_id,

sum(sample_times), sum(total_value),
avg(avg_value),
min(min_value), max(max_value), interval =
convert(datetime,

(convert(char(2),
month(interval_date_time)) + ‘/’
+ convert(char(2),day(interval_date_time)) + ‘/’
+ convert(char(4),year(interval_date_time)) + ‘ ’
+ convert(char(2),datepart
(hour,interval_date_time))
+ ‘:00’)

| | ) |
|---|---|
| FROM | p_history_5 min |
| WHERE | interval_date_time < (dateadd (day, −1, |
| | getutcdate( ))) |
| AND | interval_date_time > (SELECT latest_hourlyhistory |

FROM p_sysparams)

GROUP BY [host_id], [object_id], instance_id,

convert(datetime,

(convert(char(2),month
(interval_date_time)) + ‘/’
+ convert(char(2),day(interval_date_time)) + ‘/’
+ convert(char(4),year(interval_date_time)) + ‘ ’

+ convert(char(2),datepart(hour,interval_date_time))

+ ‘:00’)

)
INSERT INTO p_history_daily

([host_id], [object_id], instance_id, sample_times,
total_value, avg_value, min_value, max_value,
interval_date_time)

SELECT [host_id], [object_id], instance_id,

sum(sample_times), sum(total_value),
avg(avg_value),
min(min_value), max(max_value), interval =
convert(datetime,

(convert(char(2),
month(interval_date_time)) + ‘/’
+ convert(char(2),day(interval_date_time)) + ‘/’

+ convert(char(4),year(interval_date_time)) +

‘ 00:00’)

| | ) |
|---|---|
| FROM | p_history_hourly |
| WHERE | interval_date_time < (dateadd (“day”, −1, |
| | getutcdate( ))) |
| and | dateadd(“hour”, −12, interval_date_time) > (SELECT |

latest_dailyhistory FROM p_sysparams)

GROUP BY [host_id], [object_id], instance_id,

convert(datetime,

(convert(char(2),
month(interval_date_time)) + ‘/’
+ convert(char(2),day(interval_date_time)) + ‘/’
+ convert(char(4),year(interval_date_time)) +
‘ 00:00’)

).

The dot notation as used in the present invention is an Indexed Field to the database. Normally, an Indexed Field consists of a single number, or a single text label. The dot notation used herein consists of multiple text labels, which are ordered and are separated by dots. The dot notation representation of XML allows any subtree within XML to be searched by the “like” keyword in ANSI-SQL. Matching XML subtrees would otherwise require extensive parsing and processing, significantly impacting the scalability of the service provider. Basically, using dot notation to represent XML data in databases is a significant innovation because it allows XML to be easily processed by Relational Databases.

Each ordered field within a dot notation sequence can be a description in itself. Therefore, a single dot notation sequence conveys simultaneous the following information:

a) Multiple Indexes

b) Multiple Labels

c) Ordered hierarchy of a) and b)

d) An entire tree data structure, when used in groups

The use of dot notation representation of XML enables development of management software within months which functionality can compare to and exceed those previously developed at great expense.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A management system for managing an installation that engages in transactions with individuals via the Internet, the installation including at least one server whose operation is controlled by a given operating system and which includes first Internet connections, and at least one workstation for providing management information to users associated with the installation, said management system comprising:
a management operating system physically connected to the server of the installation and having a second Internet connection separate from the first Internet connection, said management operating system comprising means for collecting operating status data from the server of the installation; and
a management server system having a third Internet connection for communication with the management operating system and comprising means for receiving the collected operating status data and comparing operating status values represented by the data with threshold values.

2. A management system for managing an installation that engages in transactions with individuals via the Internet, the installation including at least one server whose operation is controlled by a given operating system and which includes first Internet connections, and at least one workstation for providing management information to users associated with the installation, said management system comprising:
a management operating system operatively associated with the server of the installation and having a second Internet connection separate from the first Internet connection, said management operating system comprising means for collecting operating status data from the server of the installation in a platform-independent format; and
a management server system having a third Internet connection for communication with the management operating system and comprising means for receiving the collected operating status data in the platform-independent format, converting that data into a second format and comparing operating status values represented by the data in the second format with threshold values.

3. The system of claim 1 or 2 wherein the given operating system contains at least one tuning script that is activatable to modify a respective operating characteristic of the server, and said management system is configured to modify the operation of said server only by activating the at least one tuning script.

4. A storage medium contain a set of databases including a standard metrics database and at least one summary metrics database and at least one summary metrics database, the standard metrics database containing a plurality of first data elements obtained by directed measurement of an operating parameter of the server at first time intervals and the at least one summary metrics database containing a plurality of second data elements obtained by averaging or summing groups of the first data elements over second time intervals longer than the first time intervals, each second data element being stored only for a given time.

5. A method for displaying information for use in controlling an installation that engages in transactions via the Internet, the installation including at least one server and at least one work station for providing management information to personal associated with the installation, the work station having a monitor that provides a display that includes an icon tray and a main display area, said method comprising:
displaying a management message icon in the icon tray when the installation is operating in a manner such that intervention by operating personal is not indicated;
changing the appearance of the management message icon when intervention by operating personal is indicated.

6. The method of claim 5 further comprising displaying, under control of operating personal, management messages in the main display area after the appearance of the management icon has changed, the messages including identification of the problem to be resolved and available solutions.

7. A method of managing an insolation that engages in transactions over the Internet, the installation including a management system for managing an installation that engages in transactions with individuals via the Internet, the installation including at least one server whose operation is controlled by a given operating system and which includes first Internet connections, and at least one workstation for providing management information to users associated with the installation, said method comprising: connecting a management operating system to the given operating system and providing the management operating system with a second Internet connection separate from the first Internet connections;
operating the management operating system to collect operating status data from the server of the installation in a platform-independent format;
providing a management server system having a third Internet connection for communication with the management operating system, the management server system having means for receiving the collected operating status data in the platform-independent format, converting that data into a second format and comparing operating status valves represented by the data with threshold valves;
when the comparing step provides an indication that an operating status value is outside of a desired range, transmitting a warning indication to the at least one work station.

8. A method for displaying the operating status of a computer-based system, comprising:
displaying an icon representing at least one operating parameter of the computer-based system in a task tray of a computer screen; and
altering the visual appearance of the icon as a function of the current value of the at least one operating parameter, which current value is representative of the current operating status of the computer-based system.

9. A method for deriving data representing a plurality of operating parameters of a computer-based system, comprising:
measuring the value of each of the parameters and producing a digital representation of the value of each of the parameters in an XML format; and
converting each digital representation from the XML format to a self-describing representation composed of text in a dot notation format.
